(19) United States
(12) Patent Application Publication
(10) Pub. No.: US 2023/0288545 A1
(43) Pub. Date: Sep. 14, 2023

(54) METHOD FOR DETECTING DIRT ACCUMULATED ON AN OPTICAL SENSOR ARRANGEMENT

(71) Applicants: DAIMLER AG, Stuttgart (DE); ROBERT BOSCH GMBH, Stuttgart (DE)

(72) Inventors: Philipp SCHINDLER, Karlsruhe (DE); Andreas SCHARF, Stuttgart (DE); Robin HEINZLER, Böblingen (DE)

(21) Appl. No.: 18/006,157

(22) PCT Filed: Jun. 15, 2021
(86) PCT No.: PCT/EP2021/066095

§ 371 Date: Jan. 20, 2023

(30) Foreign Application Priority Data
Jul. 21, 2020 (DE) 10 2020 119 116.2

(51) Int. Cl. G01S 7/497; G01S 7/48; G01S 17/89

(52) U.S. Cl. CPC G01S 7/497; G01S 7/4802; G01S 17/89; G01S 2007/4975

(57) ABSTRACT

A method for detecting dirt in the signal path of an optical sensor arrangement. To detect objects via a plurality of photodetector elements of the sensor arrangement, light signals are reflected at the objects to be detected. A respective object is classified according to its type and the object is assigned to an object class with a specified reflectivity during the classification. A distance to the object is measured. Crosstalk of the detected light signals on a plurality of photodetector elements is determined and a degree of dirtying is ascertained on the basis of the specified reflectivity ascertained during the classification, the distance and a degree of the crosstalk.

### FIELD

The invention concerns a method for detecting dirt in the signal path of an optical sensor array.

### BACKGROUND

DE 10 2005 003 970 A1 discloses a method for identifying dirt on a sensor array comprising a lidar sensor on a vehicle, wherein an area covered by the sensor array is divided into different sub-areas and wherein sensor signals sent to a sub-area from a specific surrounding area are assessed in order to determine the operability of the sensor array. This involves assessing sensor signals that are detected sequentially for different sub-areas while driving past them to the specific surrounding area. The sub-areas for this are designated in such a way that multiple individual sensors whose detection ranges each represent one sub-area are inspected.

### SUMMARY

The invention is intended to provide a method for detecting dirt in the signal path of an optical sensor array that improves upon the prior art.

The invention achieves this goal by means of a method having the features presented in the claims.

Advantageous embodiments of the invention are the object of the subordinate claims.

In the method according to the invention for detecting dirt in the signal path of an optical sensor array, such as a lidar sensor or camera, in order to detect objects, light signals reflected on the objects are detected by multiple photodetector elements in the sensor array. Each object is classified based on its type, and when it is classified the object is assigned to an object class with a predetermined reflectivity. A distance to the object is then measured, crosstalk in the detected light signals onto multiple photodetector elements is identified on, and a degree of dirtiness is determined based on the predetermined reflectivity ascertained during classification, the distance, and the magnitude of the crosstalk.

Dirtiness or contamination of the optical paths of sensor arrays reduces their detection performance and therefore the availability and reliability of a system using the data detected by the sensor array, in particular a driver assistance system or a system for automated, in particular fully automated or autonomous, operation of a vehicle and/or robot. If there is contamination inside the sensor array, this is a latent defect that cannot easily be remedied. Contamination on the cover of the sensor array, however, can be removed by appropriate cleaning systems. Contamination detection is therefore essential for the operation of such a cleaning system and for monitoring safety-related intrinsic limitations.

The method allows for exceptionally easy and reliable detection of dirt or contamination in the optical paths of sensor arrays, so that system limitations of systems using the data detected by the sensor array can be accurately recognized and the sensor array can be cleaned. This increases sensor availability and therefore system availability. In addition, the system's safety is increased through reliable detection of performance limitations.

In one possible embodiment of the method, the degree of dirtiness is determined using at least one look-up table. This can be done with exceptional ease and reliability.

In another possible embodiment of the method, the at least one look-up table is generated based on at least one reference measurement taken by the sensor array. This allows for optimal referencing.

In one possible embodiment of the method, crosstalk is identified by looking for testing an image detected by the sensor array for typical crosstalk structures. This allows for easy and reliable determination of crosstalk.

In one possible embodiment of the method, linear structures are used as the structures and then there is determined to be crosstalk if the linear structures are blurred. Such an embodiment is particularly well suited for sensor arrays configured as so-called line scanners, in particular lidar, and allows for easy and very reliable identification of crosstalk. In particular, as the degree of blurring increases, a higher degree of crosstalk is identified.

In one possible embodiment of the method, crosstalk is identified by comparing dimensions of the detected object to expected dimensions for such an object, and an increasing degree of crosstalk is identified with increasingly positive deviation of the dimensions for the detected object from the expected dimensions. This embodiment also allows for easy and reliable identification of crosstalk.

In one possible embodiment of the method, the expected dimensions are determined from dimensions determined for an object class corresponding to the object based on at least one reference measurement taken by the sensor array.

In one possible embodiment of the method, the expected dimensions are derived from an object class corresponding to the object, wherein objects belonging to the object class have standardized dimensions. Traffic signs are examples of such objects. Because of the standardized dimensions of such objects, the results of comparing them with the dimensions of the detected object are very precise and reliable.

### DESCRIPTION OF THE FIGURES

Examples of the invention are explained in more detail below, with reference to figures.

The figures show:

FIG. 1 a schematic perspective view of a first embodiment example of a lidar and its detection range during the transmission of laser radiation,

FIG. 2 a schematic perspective view of the lidar and its detection range according to FIG. 1 during reception of the reflected laser radiation,

FIG. 3 a schematic view of a scene with multiple objects, and

FIG. 4 a schematic of an image of the scene from FIG. 3 detected by a lidar.

### DETAILED DESCRIPTION

The same items are marked with the same references in all figures.

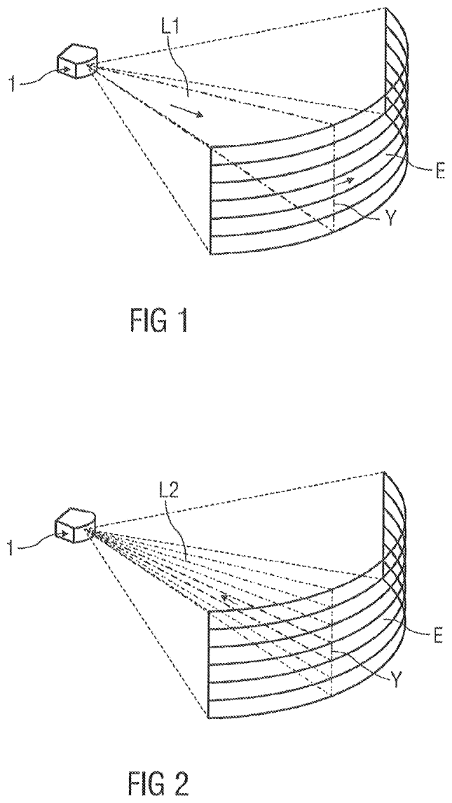

FIG. 1 shows a perspective view of a first embodiment of an optical sensor array 1 configured as lidar and its detection area E during transmission of a light signal L1 configured as laser radiation. FIG. 2 shows a perspective view of the sensor array 1 and the detection area E as in FIG. 1 during reception of reflected light signals L2 configured as laser radiation.

The sensor array 1 is, for example, a component of a vehicle and/or robot that is not shown, wherein data detected by the sensor array 1 in a vehicle's and/or robot's surroundings are used to control the automated, in particular fully automated or autonomous, operation of the vehicle and/or robot.

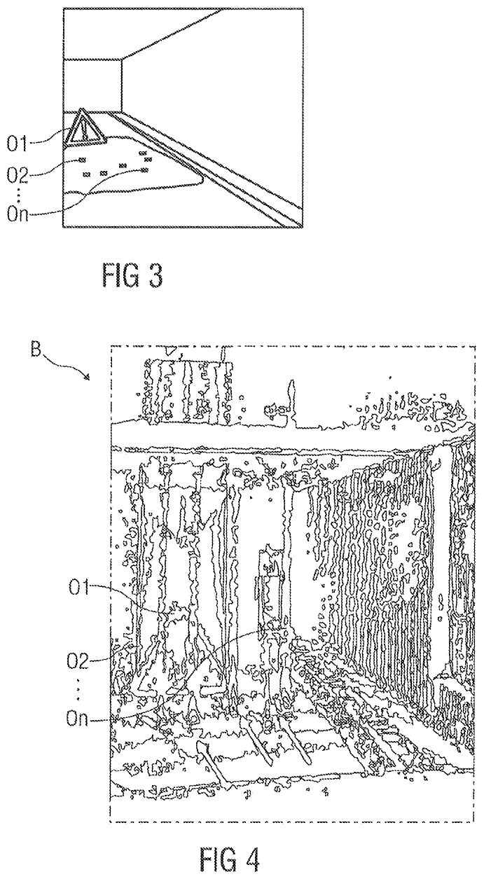

The sensor array 1 configured as lidar transmits the light signals L1, in particular laser pulses, which are reflected by nearby objects O1 to On shown in FIG. 3 in the detection area E and detected by the lidar as reflected light signals L2.

Here the sensor array 1 includes multiple receiver elements that are not shown in detail, which are imaged onto varying solid angles of the detection area E. In particular, the receiver elements are photodetector elements.

In the embodiment example shown, the sensor array 1 configured as lidar is a so-called line scanner, which illuminates a line Y of its full sight or detection area E at the same time and images different solid angles on a so-called imager or diode field, at the same time. This illuminates the entire vertical detection area E and achieves vertical resolution through multiple individual receivers, in particular photodetector elements, at the same time. This line Y is then deflected horizontally through the detection area E, for example by rotating a transmitter and a receiver in the sensor array 1.

If there is contamination, in particular smearing or dirt, in the signal path of the sensor array 1, the transmitted and received light signals L1, L2 are at least partially scattered by the contamination and therefore detected on multiple individual receivers in the sensor array 1. Such scattering of the reflected and detected light signals L2 to multiple photodetector elements is known as crosstalk.

Therefore, in order to detect contamination in the signal path of the sensor array 1, after an object O1 to On is detected by the sensor array 1, the object O1 to On is classified based on its type, and when the object O1 to On is classified it is assigned to an object class with a predetermined reflectivity. A distance to the object O1 to On is then measured, and crosstalk in the detected light signals L2 is identified on multiple photodetector elements, wherein a degree of dirtiness is determined based on the predetermined reflectivity ascertained during classification, the distance, and a magnitude of the crosstalk.

FIG. 3 shows a scene with multiple objects O1 to On, wherein one object O1 is a traffic sign and the other objects O2 to On are highly reflective road markings.

If this scene is measured or scanned by a sensor array 1 configured as a lidar line scanner, the image B shown in FIG. 4 results.

It clearly shows that the objects O1 to On are detected by the sensor array 1 as larger than they are in reality. This results from crosstalk, wherein the degree of crosstalk depends on the reflectivity of the corresponding object O1 to On, a distance from the sensor array 1 to the corresponding object O1 to On, and optical scattering resulting from contamination of the signal path of the sensor array 1.

The distance from objects O1 to On to the sensor array 1 is known because it is determined by the lidar directly by run time measurement. The reflectivity of the individual objects O1 to On can be determined, for example, based on the classification of the objects O1 to On according to their type, as a traffic sign, for example, and then refined using data from a digital street map. For this the determined reflectivities are for example entered into the digital maps by so-called mapping vehicles and/or fleet data and thereby kept strictly current and extremely precise. In this way the contamination in the signal path can be derived directly from the degree of crosstalk. Based on the crosstalk, it is also possible to determine in which solid angle the contamination exists, because scattering only appears when there is overlap with the received light signals L2. Therefore, for example, if there is contamination on the left in the detection area of the sensor array 1 configured as a lidar line scanner, then the crosstalk in that area will be very strong, as long as the optical aperture overlaps with the contamination. With decreasing overlap, the effect becomes smaller.

For example, the degree of dirtiness is determined based on at least one look-up table, which is generated based on at least one reference measurement taken by the sensor array 1 or by other similar sensor arrays 1, such as sensor arrays 1 on other vehicles and/or robots.

Crosstalk is therefore identified by testing the image B detected by the sensor array 1 for typical crosstalk structures. For example, for a sensor array 1 configured as a lidar line scanner, linear structures are used as the structures and then there is determined to be crosstalk if the linear structures are blurred. Therefore, as the degree of blurring increases, a higher degree of crosstalk can be identified.

Crosstalk can alternatively or additionally be identified by comparing dimensions of the detected objects O1 to On to expected dimensions for such an object O1 to On, wherein an increasing degree of crosstalk is identified with increasingly positive deviation of the dimensions for the detected object O1 to On from the expected dimensions. Therefore, the expected dimensions are determined from dimensions determined for an object class corresponding to the object O1 to On in the classification based on at least one reference measurement taken by the sensor array 1. Alternatively or additionally, the expected dimensions are derived from an object class corresponding to the object O1 to On, wherein objects O1 to On belonging to the object class, such as traffic signs, have standardized dimensions.

The previously described method for detecting contamination in the signal path of the sensor array 1 can also be applied to sensor arrays 1 that include at least one camera as a sensor. Here light from other traffic participants and infrastructure and from vehicular or robotic light sources is used to illuminate the objects O1 to On, and light signals L2 reflected from the objects O1 to On are detected by the camera. The effects that appear here are comparable to so-called lightsabers, which are generated by the lights of other vehicles if water streaks from windshield wipers remain on the windshield of a vehicle. Such an effect can be generated on traffic signs, for example, by vehicle light, due to increased illumination of traffic signs by pixel light, for example. In order to strengthen the resulting effect, the duration of exposure of the camera can be adjusted accordingly, in particular increased.

### LIST OF REFERENCE INDICATORS

1 Sensor array
B Image
E Detection area
L1 Light signal
L2 Light signal
O1 to On Object
Y Line

1-10. (canceled)

11. A method for detecting dirt in the signal path of an optical sensor array, comprising:
objects are detected by using multiple photodetector elements in the sensor array to detect light signals reflected on the objects,
each object is classified according to its type, and when it is classified the object is assigned to an object class with a predetermined reflectivity,
a distance to the object is determined,
crosstalk in the detected light signals onto multiple photodetector elements is identified, and
a degree of dirtiness is determined based on the predetermined reflectivity ascertained during classification, the distance, and a magnitude of the crosstalk.

12. The method as in claim 11, wherein the degree of dirtiness is determined using at least one look-up table.

13. The method as in claim 12, wherein the at least one look-up table is generated based on at least one reference measurement taken by the sensor array.

14. The method as in claim 11, wherein crosstalk is identified by testing an image detected by the sensor array for typical crosstalk structures.

15. The method as in claim 14, wherein
linear structures are used as the structures and
there is then determined to be crosstalk if the linear structures are blurred.

16. The method as in claim 15, wherein as the degree of blurring increases, a higher degree of crosstalk is identified.

17. The method as in claim 11, wherein crosstalk is identified as follows:
dimensions of the detected object are compared to expected dimensions for such an object, and
an increasing degree of crosstalk is identified with increasingly positive deviation of the dimensions for the detected object from the expected dimensions.

18. The method as in claim 17, wherein the expected dimensions are determined from dimensions determined for an object class corresponding to the object based on at least one reference measurement taken by the sensor array.

19. The method as in claim 18, wherein the expected dimensions are derived from an object class corresponding to the object, wherein objects belonging to the object class have standardized dimensions.

20. Use of a method as in claim 11 in a vehicle and/or robot to perform a fully automated or autonomous operation.
